(19) United States
(12) Patent Application Publication
(10) Pub. No.: US 2021/0333937 A1
(43) Pub. Date: Oct. 28, 2021

(54) TOUCH SCREENS

(71) Applicant: Beijing Zenithnano Technology Co., Ltd., Beijing (CN)

(72) Inventors: Yuchun Zhang, Jiangsu Province (CN); Shudong Zhong, Beijing (CN)

(21) Appl. No.: 17/230,693

(22) Filed: Apr. 14, 2021

(30) Foreign Application Priority Data
Apr. 28, 2020 (CN) CN202010349454.5

(51) Int. Cl. G06F 3/044; G06F 3/041; G06F 1/16; G06F 3/047

(52) U.S. Cl. CPC G06F 3/0445; G06F 3/0412; G06F 2203/04103; G06F 3/047; G06F 1/1652

(57) ABSTRACT

The present disclosure discloses a touch screen, including a display region and a transmission region. The transmission region is arranged on at least one side around the display region. The touch screen includes a transparent cover plate, a first adhesive layer, a first low-resistance conductive layer, a first flexible film substrate, a second adhesive layer, a second low-resistance conductive layer, and a second flexible film substrate sequentially from top to bottom. The first low-resistance conductive layer and the second low-resistance conductive layer include an electrical conduction layer of a continuous structure. The electrical conduction layer includes metal and an oxide/nitride of the metal. The first low-resistance conductive layer includes a first touch conductive layer and a first wire integrally formed. The second low-resistance conductive layer includes a second touch conductive layer and a second wire integrally formed.

### CROSS-REFERENCES TO RELATED APPLICATIONS

This application claims priority to Chinese Patent Application No. CN202010349454.5, entitled “TOUCH SCREENS”, filed on Apr. 28, 2020, the entireties of which are incorporated herein by reference in their entirety for all purposes.

### TECHNICAL FIELD

The present disclosure relates to touch screens.

### BACKGROUND

In recent years, touch screens have the characteristics of human-computer interaction, and have been widely used in electronic products such as smartphones, GPS navigator systems, tablet PCs, personal digital assistants (PDAs), and laptop PCs. Touch panels are configured to be used on display screens of these appliances to allow users to perform interactive input operations, thereby improving the efficiency of the input operations. Unfortunately, conventional touch screens are inadequate.

### SUMMARY

In order to solve the above problems, the present disclosure provides a touch screen that is lighter and thinner while maintaining high light transmittance. The touch screen includes a display region and a transmission region. The transmission region is arranged on at least one side around the display region. The touch screen includes a transparent cover plate, a first adhesive layer, a first low-resistance conductive layer, a first flexible film substrate, a second adhesive layer, a second low-resistance conductive layer, and a second flexible film substrate sequentially from top to bottom. The first low-resistance conductive layer and the second low-resistance conductive layer include an electrical conduction layer of a continuous structure. The electrical conduction layer includes metal and an oxide/nitride of the metal. The first low-resistance conductive layer includes a first touch conductive layer and a first wire integrally formed. The second low-resistance conductive layer includes a second touch conductive layer and a second wire integrally formed. The first touch conductive layer and the second touch conductive layer correspond to the display region. The first wire and the second wire correspond to the transmission region. A thickness of the first wire is greater than that of the first touch conductive layer. A thickness of the second wire is greater than that of the second touch conductive layer.

Preferably, a refractive index of the first adhesive layer is 1.6-1.8, and a refractive index of the second adhesive layer is 1.8-2.0.

Preferably, the thicknesses of the first touch conductive layer and the second touch conductive layer are 80-120 nm.

Preferably, a thickness of the electrical conduction layer is 3-10 nm.

Preferably, the electrical conduction layer includes a highest point and a lowest point, and a distance between the highest point and the lowest point is less than 4 nm.

Preferably, the metal is silver, copper, or silver-copper alloy.

Preferably, a thickness difference between the first wire and the first touch conductive layer and a thickness difference between the second wire and the second touch conductive layer are 18-22 nm.

Preferably, a horizontal projection distance of the first wire above a side face of the first touch conductive layer is 0-5 nm.

Preferably, a method for forming the electrical conduction layer includes:

step 1), placing a metal target in a chamber filled with inert gas, and introducing oxygen or nitrogen during sputtering; and

step 2), placing a baffling fixture in the display region to continuously sputter the transmission region according to the method in step 1.

### BRIEF DESCRIPTION OF THE DRAWINGS

FIG. 1 is a top view of a touch screen according to an embodiment of the present disclosure.

FIG. 2 is a schematic diagram of a profile in an A-A′ direction in FIG. 1.

FIG. 3 is a schematic diagram of an electrical conduction layer of a continuous structure.

FIG. 4 is a schematic diagram of another embodiment of a profile in an A-A′ direction in FIG. 1.

### DETAILED DESCRIPTION OF THE EMBODIMENTS

At present, a common structure in touchpads is a GFF structure. G refers to a cover plate, which plays a protective role, and F refers to a film carrying a conductive layer. Two films respectively induce and drive a touch function together. In the prior art, the conductive layer is generally made of ITO, and an ITO film with a thickness of several hundred nanometers is sputtered on the film. However, the overall thinning trend of the touch screen makes an overall thickness too large. Moreover, the ITO has the characteristics of brittleness and high impedance. In the transmission region, materials such as silver paste with low impedance need to be used for electric transmission, which requires additional strengthening on lap joints. Otherwise, the display and transmission regions may be separated, affecting the touch function. In addition, the display region and the transmission region need to be made in steps in the manufacturing process. First, the ITO film is sputtered, conductive silver paste is printed, and then the display region and the transmission region are patterned respectively. The above manufacturing process is complicated and tedious, and the cost is high. Besides, the display region and the transmission region are made of different materials.

By using words of orientation such as “atop”, “on”, “uppermost”, “below” and the like for positions of various elements in the laminated structure provided in the present disclosure, we refer to a relative position of an element with respect to horizontally-disposed, upwardly-facing support. It is not intended that the films or articles should have any particular orientation in space during or after their manufacture.

The term “island structure” in the present disclosure means that metal presents an island-like structure on a bearing layer on a micro level and the island is not connected to other islands.

The term “continuous structure” in the present disclosure means that the metal presents a shape like a continuous mountain on the bearing layer on a micro-level and has to be connected at the valley, or means that the metal presents a flat layered structure.

The term “transparent” when used with respect to a film or laminated glazing article means that there is no visibly noticeable distortion, haze, or flaws in the film or article as detected by the naked eye at a distance of about 1 meter.

The term “oxide/nitride of metal” means a binary compound composed of the metal and oxygen or a binary compound of the metal and nitrogen.

In order to make the objectives, technical solutions, and advantages of the present disclosure clearer, the present disclosure is further described in detail below in combination with embodiments. It is understood that the specific embodiments described herein are intended only to explain the present disclosure and are not to define the present disclosure.

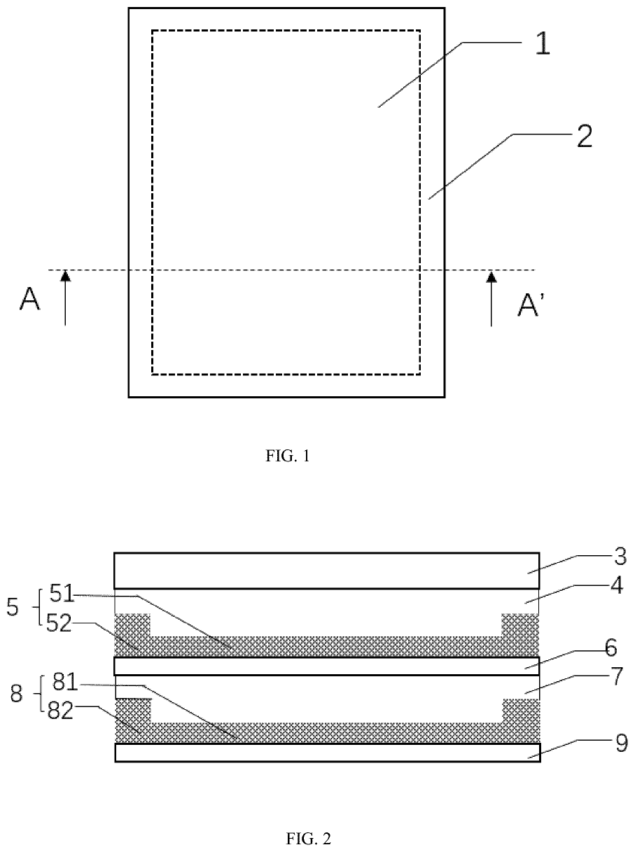

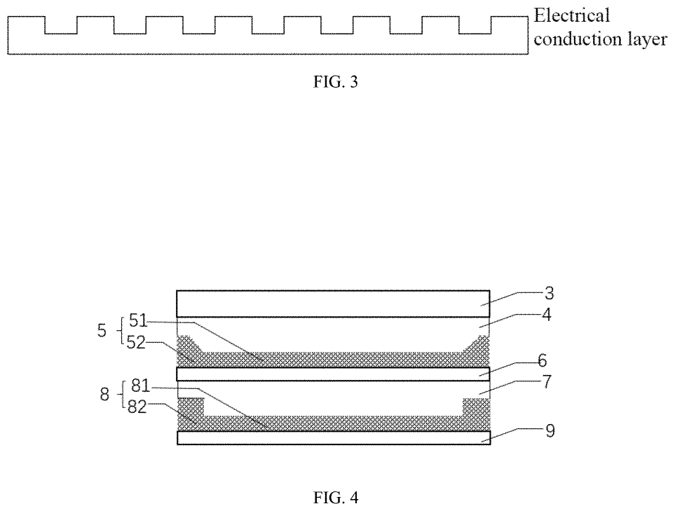

As shown in FIG. 1 and FIG. 2, this embodiment discloses a touch screen, including a display region 1 and a transmission region 2. The transmission region 2 is arranged on at least one side around the display region 1. The touch screen includes a transparent cover plate 3, a first adhesive layer 4, a first low-resistance conductive layer 5, a first flexible film substrate 6, a second adhesive layer 7, a second low-resistance conductive layer 8, and a second flexible film substrate 9 sequentially from top to bottom. The first low-resistance conductive layer 5 and the second low-resistance conductive layer 8 include an electrical conduction layer of a continuous structure. The electrical conduction layer is as shown in FIG. 3. The electrical conduction layer includes metal and an oxide/nitride of the metal. The first low-resistance conductive layer includes a first touch conductive layer 51 and a first wire 52 integrally formed. The second low-resistance conductive layer includes a second touch conductive layer 81 and a second wire 82 integrally formed. The first touch conductive layer 51 and the second touch conductive layer 81 correspond to the display region 1. The first wire 52 and the second wire 82 correspond to the transmission region 2. A thickness of the first wire 52 is greater than that of the first touch conductive layer 51. A thickness of the second wire 82 is greater than that of the second touch conductive layer 81.

In the prior art, the display region and the transmission region are made of different materials, and are manufactured in different processes. Generally, a lap region needs additional reinforcement; otherwise, the lap region is easy to detach, resulting in a short circuit. The technical feature of the present disclosure that the wire part (including the first wire or the second wire hereinafter) corresponding to the transmission region and the touch conductive layer part (including the first touch conductive layer or the second touch conductive layer hereinafter) corresponding to the display region are integrally formed solves the problem of a tedious manufacturing process, and a connection effect of the lap region is better. The “integrally formed” herein means the formation through the same method, the same main equipment, or in the same procedure in a film-forming process. The low-resistance conductive layer of the present disclosure is integrally formed in the manufacturing process, but is differentiated in functions. The differentiation of its functions can only be realized after the subsequent processing, for example, the touch conductive part and the wire part are designed and lasered with different patterns to respectively form a corresponding touch region and a corresponding wire region.

In the prior art, the reason why the display region and the transmission region are made of different materials is that the impedance of an existing ITO material is too large, and conductive silver paste with low impedance is usually used in the transmission region. Due to the low resistance characteristics of the low-resistance conductive layer (including the first low-resistance conductive layer or the second low-resistance conductive layer hereinafter) of the present disclosure, the same material can be used for signal transmission, but a signal transmission wire is not only affected by the resistance, but also affected by the reactance. Therefore, the thickness of the first wire and the thickness of the second wire are greater than the thickness of the first touch conductive layer and the thickness of the second touch conductive layer, which greatly reduces the impedance. However, the low-resistance conductive layer in the prior art generally includes an electrical conduction layer composed of metal. However, the metal electrical conduction layer is too thick, which is easy to affect the light transmittance and cause chromatic aberration due to its different refractive index from other layer structures. However, due to the high surface energy characteristics of the metal, an island structure may generally be formed with ordinary preparation methods. The island structure affects the migration of metal particles, thus affecting the conductivity of the layer structure. The electrical conduction layer of the present disclosure solves the technical problem through a combination of metal and an oxide/nitride of the metal.

The transparent cover plate 3 of the present disclosure may be planar or non-planar. The material may be an inorganic material, for example, glass, quartz, or sapphire, but is not limited thereto, and may also be organic plastic. For example, the material may be polyethylene terephthalate (PET), polyethylene naphthalate (PEN), polycarbonate (PC), polyethersulfone (PES), and polyimide (PI), but is not limited thereto, and may also be composed of a combination of organic material and organic plastic. In another embodiment, the transparent cover plate 3 is preferably a sapphire of 2.5D or 3D. 2.5D herein means that the top and bottom are flat planes and two sides of an upper surface are arc-shaped. 2.5D allows the transmission region to be a visually narrow bezel. 3D means that the lower surface is flat and the upper surface is arc-shaped.

The flexible film substrate is preferably an optically transparent flexible substrate, and is made of one or more materials selected from a group consisting of polyethylene terephthalate (PET), polyimide (PI), polypropylene (PP), polystyrene (PS), cellulose triacetate (TAC), FMH acrylonitrile-butadiene-styrene (ABS), polyvinyl chloride (PVC), polycarbonate (PC), polyethylene (PE), polymethyl methacrylate (PMMA), polytetrafluoroethylene, a cyclic olefin copolymer (COP, Arton), and polyethylene naphthalate (PEN).

A refractive index of the first adhesive layer 4 is 1.6-1.8, and a refractive index of the second adhesive layer 7 is 1.8-2.0. A chromatic aberration problem such as a visible etching line occurs after the low-resistance conductive layer is attached to the transparent cover plate 3 by an adhesive. In the prior art, an optical adjustment layer is generally provided, but the thickness of the product is increased. When adhesive layers with different refractive indexes are selected, the optical adjustment layer can be omitted, thereby reducing the thickness of the touch screen and saving the manufacturing process. The first adhesive layer 4 uses an adhesive with a low refractive index, and a refractive index difference with the second adhesive layer is maintained between 0.1 and 0.3. The low-resistance conductive layer of the present disclosure with lower resistance has a lower reflectivity difference, and a reflectivity difference between the adhesive layers is smaller, which has a good adjustment and matching effect on chromatic aberration generated by the low-resistance conductive layer and other layers in the display device. In other implementations, the first adhesive layer and the second adhesive layer may be an optical clear adhesive (OCA), a liquid optical clear adhesive (LOCA), or a PVB sheet adhesive.

In this embodiment, the thicknesses of the first touch conductive layer 51 and the second touch conductive layer 81 are 80-120 nm. In other embodiments, the thicknesses of the first touch conductive layer 51 and the second touch conductive layer 81 are 90-110 nm. In other embodiments, the thicknesses of the first touch conductive layer 51 and the second touch conductive layer 81 are 100-110 nm. The thickness of the touch conductive layer in the present disclosure should not be too thick; otherwise, the light transmittance and the overall thickness of the touch device may be affected. If the touch conductive layer is too thin, the resistance of the touch conductive layer increases, which affects the conductive effect.

In this embodiment, a thickness difference between the first wire and the first touch conductive layer and a thickness difference between the second wire and the second touch conductive layer are 18-22 nm. The thickness of the wire also affects the resistance, but when the wire transmits a signal from the touch conductive layer, the transmission of the signal is affected not only by the resistance but also by the reactance. The reactance is inversely proportional to the capacitance. Therefore, the thickness of the wire is greater than that of the touch conductive layer, which can effectively reduce the impedance of the first wire 52 and the second wire 82.

In this embodiment, a horizontal projection distance of the first wire 52 above a side face of the first touch conductive layer 51 is 0-5 nm. It may be understood that the first wire 52 and the first touch conductive layer 51 form an obvious step. In other embodiments, a horizontal projection distance of an interface between the first wire 52 and the first touch conductive layer 51 is 0, that is, the interface is perpendicular to the horizontal plane. When the step form is more obvious, the conduction capability of a circuit corresponding to the transmission region is more uniform.

In this embodiment, a horizontal projection distance of the second wire 82 above a side face of the second touch conductive layer 81 is 0-5 nm. It may be understood that the second wire 82 and the second touch conductive layer 81 form an obvious step. If the step is not obvious, there is a sense of hierarchy, and the touch screen can be seen from a side, affecting the beauty. Preferably, a horizontal projection distance of an interface between the second wire 82 and the second touch conductive layer 81 is 0, that is, the interface is perpendicular to the horizontal plane.

In other embodiments, as shown in FIG. 4, an angle between the side face and the surface of the first touch conductive layer 51 is an acute angle, which may be understood as that an angle formed by the side face tilting near the display region is an acute angle. Since the first low-resistance conductive layer 5 is near the transparent cover plate 3, that is, near the human eye, if the side face tilts near the display region, it is not easy for the human eye to recognize a line formed by the side face when interacting with the display region, thus reducing appearance defects. Moreover, the horizontal projection distance of the side face is 0-5 nm, which does not affect the conductivity uniformity of the wire.

In this embodiment, the electrical conduction layer includes a composition of silver and silver oxide. In other embodiments, the electrical conduction layer includes one of a composition of copper and copper nitride, a composition of a copper-silver alloy and copper nitride, and a composition of a copper-silver alloy and silver oxide. In other embodiments, when a ratio of the metal to the oxide/nitride of the metal is 80-95:20-5, the conductive film can maintain low resistance and excellent conductivity. When an atomic percentage of oxygen or nitrogen in the oxide/nitride of the metal is 1.5 at. %-5.5 at. %, the electrical conduction effect is good.

In this embodiment, the thickness of the electrical conduction layer is 3-10 nm. Since surface energy of the oxide/nitride of the metal is less than that of the metal, after the metal and the oxide/nitride of the metal go through a particular sputtering method, the electrical conduction layer formed can maintain good light transmittance under the condition that the thickness is less than or equal to 10 nm and can also effectively alleviate the problem of forming an island structure. In other embodiments, the thickness of the electrical conduction layer is 7-10 nm. If the electrical conduction layer appears to have a highest point and a lowest point on a micro level, the thickness herein refers to a vertical height of a horizontal line of the highest point.

In this embodiment, the electrical conduction layer includes a highest point and a lowest point, and a distance between the highest point and the lowest point is less than 4 nm. The present disclosure pursues a high-electron-mobility electrical conduction layer of a continuous structure, and a distance between the highest point and the lowest point of the electrical conduction layer is less than or equal to 4 nm. The distance refers to a vertical distance between a horizontal line of the highest point and a horizontal line of the lowest point of the electrical conduction layer. Preferably, the distance between the highest point and the lowest point of the electrical conduction layer is 0-2 nm.

The electrical conduction layer includes metal and an oxide/nitride of the metal. From the perspective of microscopic forms, there are several forms: firstly, a metal layer and a metal oxide/nitride layer are superimposed, and preferably, the metal oxide/nitride layer is superimposed on the metal layer; secondly, the metal layer presents a discontinuous structure, and the metal oxide/nitride layer fills depressions of the metal layer; thirdly, the metal and the metal oxide/nitride are doped together in disorder. The microscopic form of the electrical conduction layer of the present disclosure can be either one of the above or a combination of more than two thereof. A specific form may be adjusted by the time of oxygen/nitrogen injection and an inlet volume of oxygen/gas.

In a specific implementation, the electrical conduction layer is formed by sputtering. The sputtering may be magnetron sputtering, dipole sputtering, quadrupole sputtering, or plasma sputtering. In another embodiment, the electrical conduction layer is formed by magnetron sputtering. Preferably, sheet magnetron sputtering is used.

The magnetron sputtering includes the following steps:

Step 1): A metal target is placed in a chamber filled with inert gas, and oxygen or nitrogen is introduced during sputtering. In a specific implementation, the sputtering includes placing a metal target in a chamber filled with inert gas, and introducing oxygen or nitrogen during sputtering. The metal target can be made of a single metal or an alloy metal, for example, a silver target, a copper target, or a copper-silver alloy target. Preferably, the inert gas is argon, and a filling volume of the argon is 280-320 sccm.

In a specific implementation, an inlet volume of the oxygen or nitrogen is 2-10 sccm. After oxygen or nitrogen is introduced, the metal on the metal target is bombarded to form a gas phase which reacts with oxygen or nitrogen in the chamber to form a corresponding metal compound. An inlet volume of oxygen or nitrogen affects the amount of the metal compound. The inlet volume of oxygen or nitrogen is controlled to be 2-10 sccm, so as to control the ratio of metal to the metal oxide/nitride, and further make the thickness of the electrical conduction layer less than or equal to 10 nm without producing an island structure. The conductive film has both high light transmittance and a good electrical conduction effect. In another specific implementation, an inlet volume of the oxygen or nitrogen is 4-8 sccm.

Step 2): A baffling fixture is placed in the display region to continuously sputter the transmission region according to the method in step 1. When the thickness of the conductive layer meets a requirement, the baffling fixture is placed in the display region. A size of the baffling fixture is equal to that of the display region.

Although the present disclosure is described in detail above, the foregoing description is in all respects only an illustration of the present disclosure and is not intended to limit its scope. Therefore, various improvements or transformations may be made without departing from the scope of the present disclosure.

1. A touch screen, comprising a display region and a transmission region, the transmission region being arranged on at least one side around the display region, the touch screen comprising a transparent cover plate, a first adhesive layer, a first low-resistance conductive layer, a first flexible film substrate, a second adhesive layer, a second low-resistance conductive layer, and a second flexible film substrate sequentially from top to bottom, the first low-resistance conductive layer and the second low-resistance conductive layer comprising an electrical conduction layer of a continuous structure, and the electrical conduction layer comprising metal and an oxide/nitride of the metal; and the first low-resistance conductive layer comprising a first touch conductive layer and a first wire integrally formed, the second low-resistance conductive layer comprising a second touch conductive layer and a second wire integrally formed, the first touch conductive layer and the second touch conductive layer corresponding to the display region, the first wire and the second wire corresponding to the transmission region, a thickness of the first wire being greater than that of the first touch conductive layer and/or a thickness of the second wire being greater than that of the second touch conductive layer.

2. The touch screen according to claim 1, wherein a refractive index of the first adhesive layer is 1.6-1.8, and a refractive index of the second adhesive layer is 1.8-2.0.

3. The touch screen according to claim 1, wherein the thicknesses of the first touch conductive layer and the second touch conductive layer are 80-120 nm.

4. The touch screen according to claim 1, wherein a thickness of the electrical conduction layer is 3-10 nm.

5. The touch screen according to claim 1, wherein the electrical conduction layer comprises a highest point and a lowest point, and a horizontal spacing between the highest point and the lowest point is less than 4 nm.

6. The touch screen according to claim 1, wherein the metal is silver, copper, or silver-copper alloy.

7. The touch screen according to claim 1, wherein a thickness difference between the first wire and the first touch conductive layer and/or a thickness difference between the second wire and the second touch conductive layer are/is 18-22 nm.

8. The touch screen according to claim 1, wherein a horizontal projection distance of the first wire above a side face of the first touch conductive layer is 0-5 nm.
